(19) United States
(12) Patent Application Publication
(10) Pub. No.: US 2006/0242990 A1
(43) Pub. Date: Nov. 2, 2006

(54) Temperature-maintaining device for liquor/beverage

(76) Inventor: I-Feng Kao, Tainan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/119,585

(22) Filed: May 2, 2005

(51) Int. Cl. F25D 3/08; F17C 13/00; F25B 21/00

(52) U.S. Cl. 62/457.4; 62/457.9

(57) ABSTRACT

A temperature-maintaining device includes a temperature-maintaining member delimiting a space in which a container is removably received. The temperature-maintaining member includes an inner layer, an outer layer, and a temperature-maintaining layer between the inner layer and the outer layer. The inner layer and the outer layer are made of nylon, polyester, or polyurethane. The temperature-maintaining layer is made of neoprene. At least one chilling member is mounted to an inner face of the inner layer of the temperature-maintaining member. The chilling member cools the container to the desired temperature range, and the temperature-maintaining member provides an excellent temperature-maintaining effect.

### BACKGROUND OF THE INVENTION

1. Field of the Invention

The present invention relates to a temperature-maintaining device. In particular, the present invention relates to a temperature-maintaining device for maintaining temperature of bottled liquor or bottled beverage.

2. Description of the Related Art

Some wines can provide special savor only in a predetermined temperature range. For example, the best temperature ranges for tasting non-sweet white wine, sweet white wine, and red wine are 10-12° C., 5-10° C., and 14-20° C., respectively. Refrigerators, ice buckets, or cooling containers are used to chill the wines and then maintain the temperature of the wines in the preferred range during storage or drinking.

An easy-to-carry container for cooling bottled wines has been proposed. This container comprises a substantially cylindrical hollow body and a plurality of chilling members removably placed in pockets provided on an inner periphery of the hollow body. Cooling medium is filled in each chilling member. The chilling members are placed in a refrigerator to cool the cooling medium, and the chilling members are then placed into the pockets of the container for chilling the bottled wines in the container. However, the temperature-maintaining effect could not last long, as the container is made of plastics, glass, or metal.

### SUMMARY OF THE INVENTION

A temperature-maintaining device in accordance with the present invention includes a temperature-maintaining member delimiting a space in which a container is removably received. The temperature-maintaining member includes an inner layer, an outer layer, and a temperature-maintaining layer between the inner layer and the outer layer. The inner layer and the outer layer are made of nylon, polyester, or polyurethane, and the temperature-maintaining layer is made of neoprene. At least one chilling member is mounted to an inner face of the inner layer of the temperature-maintaining member.

The chilling member cools the container to the desired temperature range, and the temperature-maintaining member provides an excellent temperature-maintaining effect.

In an embodiment of the invention, the temperature-maintaining member includes two ends that are releasably engaged with each other to define the space for receiving the container. Preferably, one of the ends of the temperature-maintaining member includes a plurality of hook fasteners, and the other end of the temperature-maintaining member includes a plurality of loop fasteners for releasably engaging with the hook fasteners.

Preferably, at least one holding section is provided on the inner face of the inner layer of the temperature-maintaining member for removably receiving the chilling member. The holding section may be a pocket.

The temperature-maintaining member may further include a layer of titanium between the temperature-maintaining layer (the layer of neoprene) and one of the inner layer and the outer layer.

The chilling member may be a freezer containing cooling medium.

In an alternative arrangement, the chilling member is a gel pack fixed to the inner face of the inner layer of the temperature-maintaining member.

In another embodiment of the invention, the temperature-maintaining member is substantially a cylindrical hollow member having an open upper end and a closed bottom end. The size of the open upper end of the temperature-maintaining member can be adjusted.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view, partly exploded, of an embodiment of a temperature-maintaining device in accordance with the present invention.

FIG. 2 is a perspective view illustrating use of the temperature-maintaining device in FIG. 1 on a bottle containing liquor or beverage.

FIG. 3 is a sectional view of the bottle and the temperature-maintaining device in FIG. 2.

FIG. 4 is a sectional view taken along plane 4-4 in FIG. 3.

FIG. 5 is a perspective view, partly exploded and partly cutaway, of a modified embodiment of the temperature-maintaining device in accordance with the present invention.

FIG. 6 is a perspective view illustrating use of the temperature-maintaining device in FIG. 5 on a bottle containing liquor or beverage.

FIG. 7 is a sectional view of the bottle and the temperature-maintaining device in FIG. 6.

FIG. 8 is a sectional view taken along plane 8-8 in FIG. 7.

FIG. 9 is a perspective view of another modified embodiment of the temperature-maintaining device in accordance with the present invention.

FIG. 10 is a sectional view similar to FIG. 3, illustrating use of the temperature-maintaining device in FIG. 9.

FIG. 11 is a perspective view, partly cutaway, of a further modified embodiment of the temperature-maintaining device in accordance with the present invention.

FIG. 12 is a sectional view similar to FIG. 7, illustrating use of the temperature-maintaining device in FIG. 11.

### DETAILED DESCRIPTION OF THE PREFERRED EMBODIMENTS

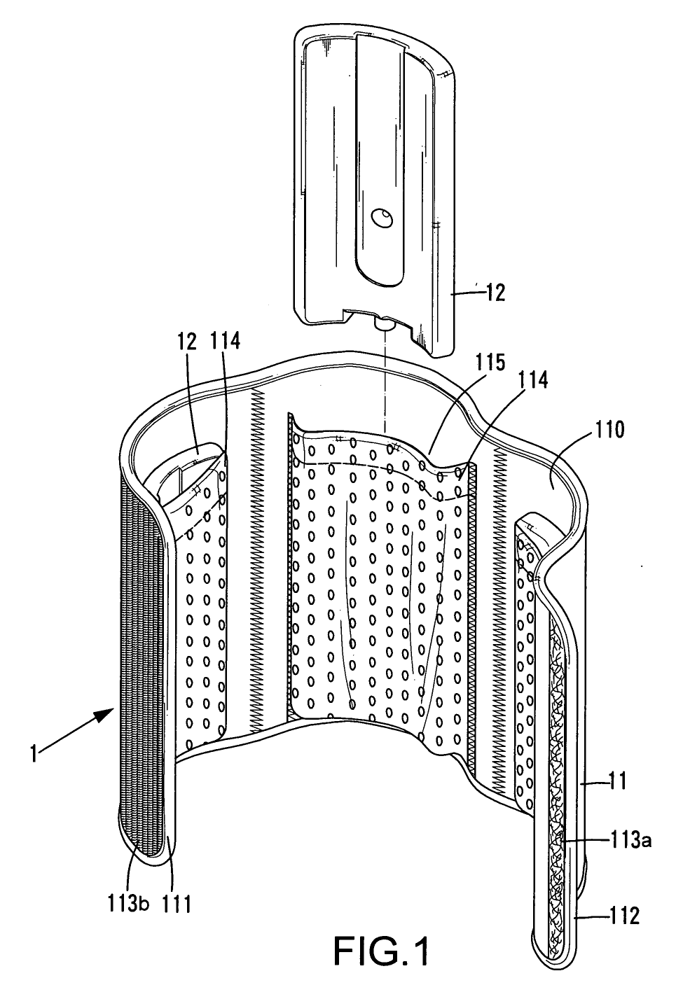

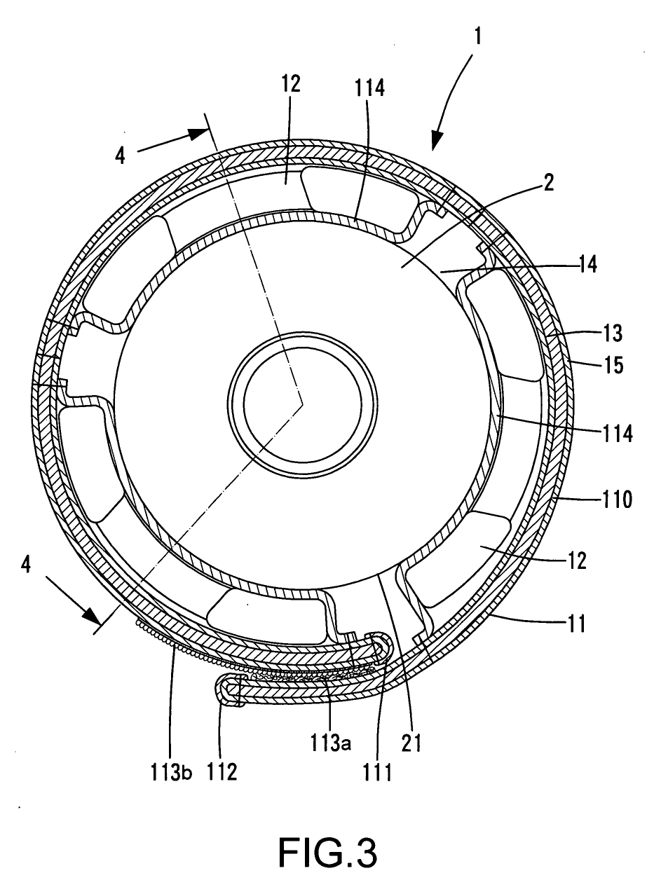

Referring to FIGS. 1 through 3, an embodiment of a temperature-maintaining device 1 in accordance with the present invention comprises a temperature-maintaining member 11 and at least one chilling member 12. In the illustrated embodiment, the temperature-maintaining member 11 includes a strap-like member having two ends 111 and 112, with hook fasteners 113a being provided on a side of one of the ends (e.g., the end 112) and with loop fasteners 113b being provided on a side of the other end 111. As illustrated in FIG. 3, the temperature-maintaining member 11 includes an inner layer 110, an outer layer 110, and a temperature-maintaining layer 13 sandwiched between the inner and outer layers 110. In this embodiment, the inner and outer layers 110 are made of, but not limited to, nylon, polyester, polyurethane, synthetic fibers, or non-woven cloth. The temperature-maintaining layer 13 is made of neoprene containing tiny bubbles therein to provide an excellent temperature-maintaining effect. However, the temperature-maintaining member 11 may further include a layer of titanium between the temperature-maintaining layer 13 (i.e., the layer of neoprene) and one of the inner layer 110 and the outer layer 110 for improving the temperature-maintaining effect.

In the illustrated embodiment, a plurality of holding sections 114 are provided on an inner face of the inner layer 100. In this embodiment, each holding section 114 is in the form of a piece of cloth sewn to the inner face of the inner layer 100 to form a pocket 115. Further, a plurality of chilling members 12 are removably received in the holding sections 114 respectively. The chilling members 12 can be placed in a refrigerator before use. In use, the chilling members 12 are placed into the pockets 115 for chilling purposes. After use, the chilling members 12 can be removed from the pockets 115 and put into a refrigerator for next use. Conventional chilling members containing cooling medium can be used. In the illustrated embodiment, each chilling member is a freezer containing cooling medium.

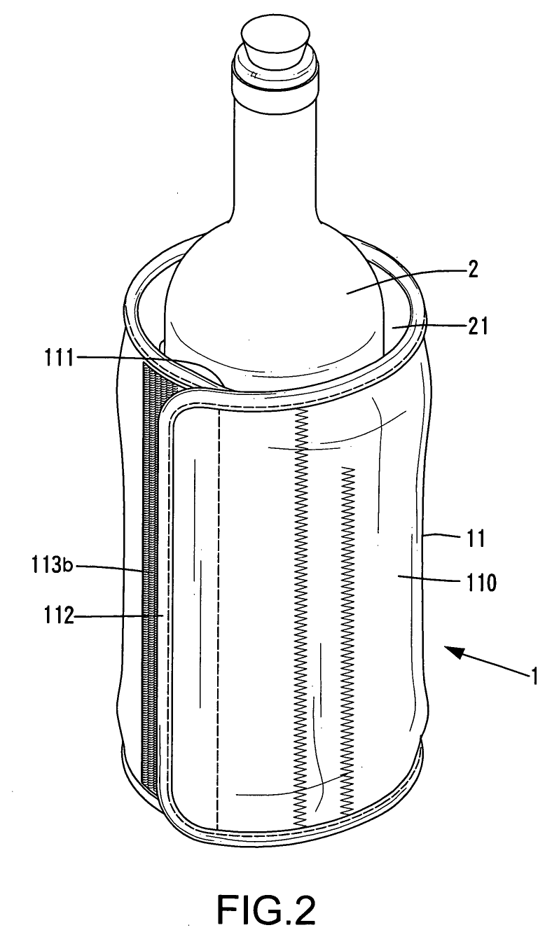

The temperature-maintaining member 11 has a length that is preferably slightly greater than an outer periphery of a container (e.g., a bottle 2) containing drinkable liquid (such as liquor or beverage) to be chilled. As illustrated in FIGS. 2 and 3, the temperature-maintaining member 11 is wrapped around the bottle 2, with two ends 111 and 112 of the temperature-maintaining member 11 overlapping with each other and with the hook fasteners 113a and the loop fasteners 113b engaging with each other.

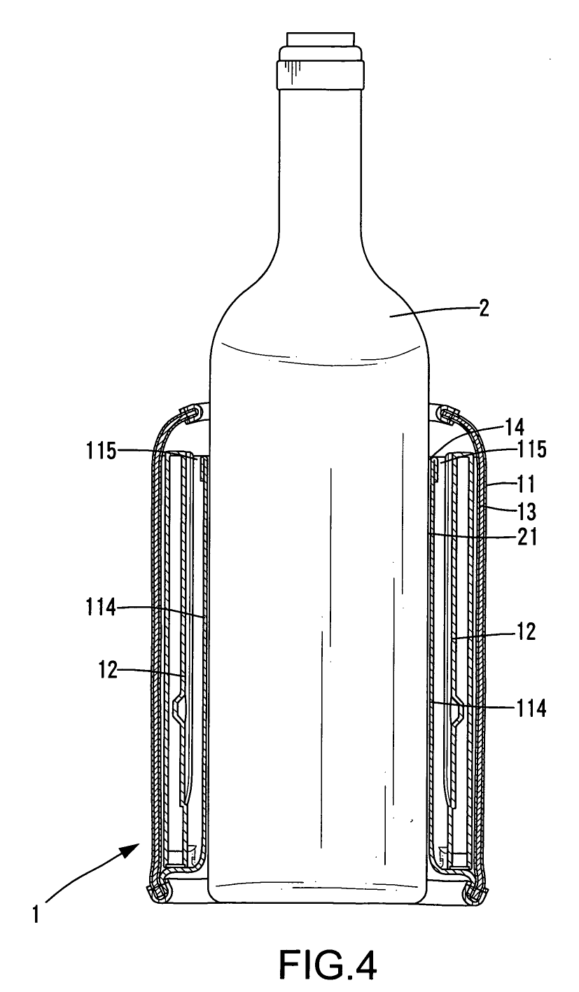

As illustrated in FIGS. 3 and 4, a temperature-maintaining space 14 is provided by the temperature-maintaining member 11 after the ends 111 and 112 thereof are engaged with each other. The chilling members 12 are in contact with the bottle 2 via the cloth forming the respective pockets 115. It is noted that the cloth can be cut to form at least one opening allowing direct contact between the chilling members 12 and the bottle 2. Further, other holding arrangements can be provided for allowing direct contact between the chilling members 12 and the bottle 2. Each chilling member 12 is preferably arcuate to conform to a section of the outer periphery of the bottle 2.

The liquor or beverage contained in the bottle 2 can be chilled to the desired temperature range by the chilling members 12. Further, the temperature-maintaining member 11 surrounding the bottle 2 forms an insulating layer to provide a longer temperature-maintaining effect.

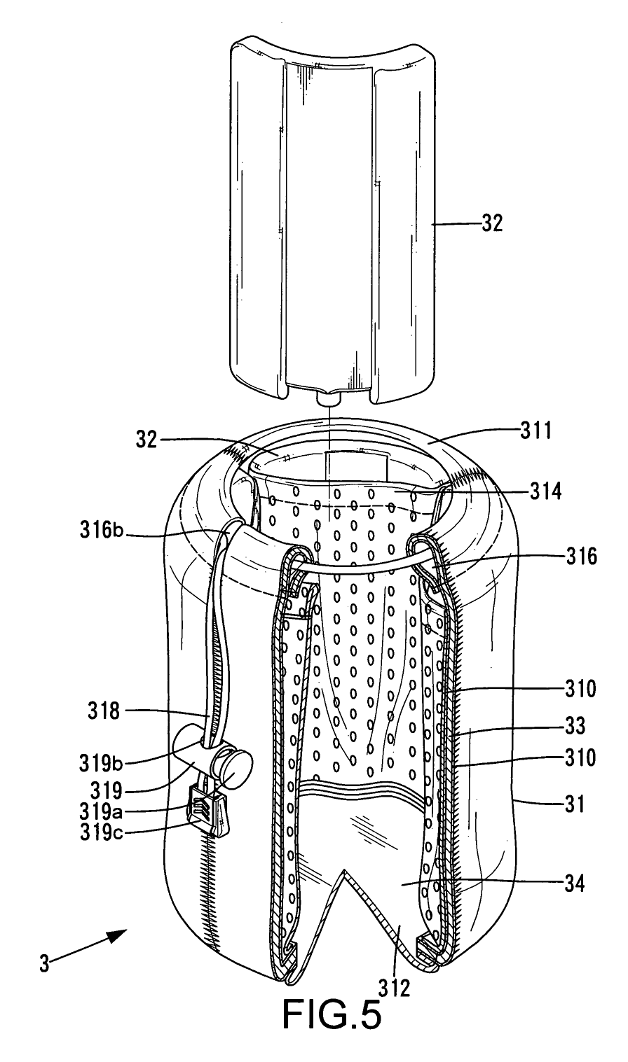

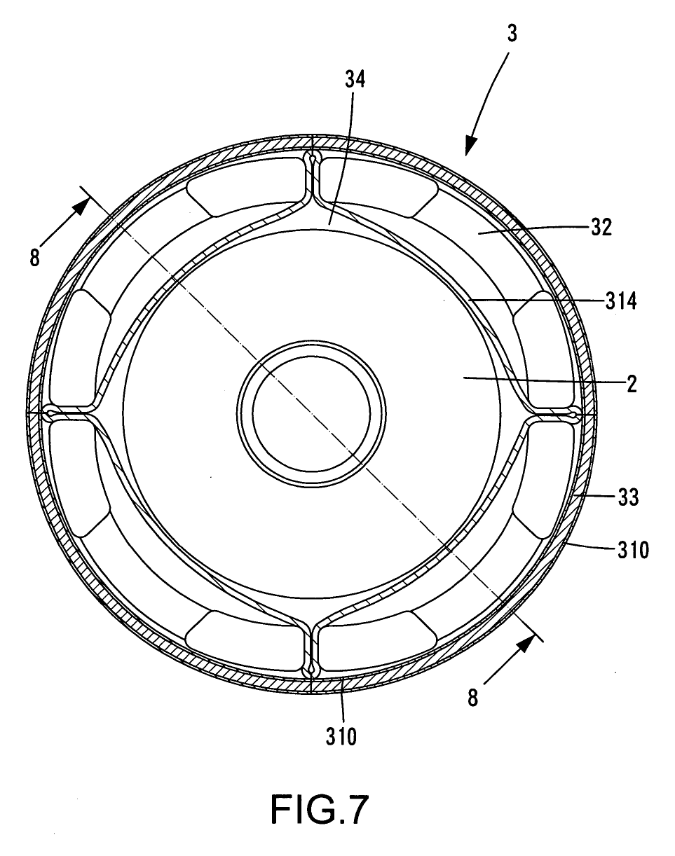

FIG. 5 illustrates a modified embodiment of the invention. In this embodiment, the temperature-maintaining device 3 comprises a temperature-maintaining member 31 and at least one chilling member 32. The temperature-maintaining member 31 is a substantially cylindrical hollow member having an open upper end 311 to allow insertion/removal of a bottle 2 containing liquor or beverage. As illustrated in FIG. 7, the temperature-maintaining member 31 includes an outer layer 310, an inner layer 310, and a temperature-maintaining layer 33 sandwiched between the inner and outer layers 310. In this embodiment, the inner and outer layers 310 are made of, but not limited to, nylon, polyester, polyurethane, synthetic fibers, or non-woven cloth. The temperature-maintaining layer 33 is made of neoprene containing tiny bubbles therein to provide an excellent temperature-maintaining effect. However, the temperature-maintaining member 31 may further include a layer of titanium between the temperature-maintaining layer 33 (i.e., the layer of neoprene) and one of the inner layer 310 and the outer layer 310 for improving the temperature-maintaining effect.

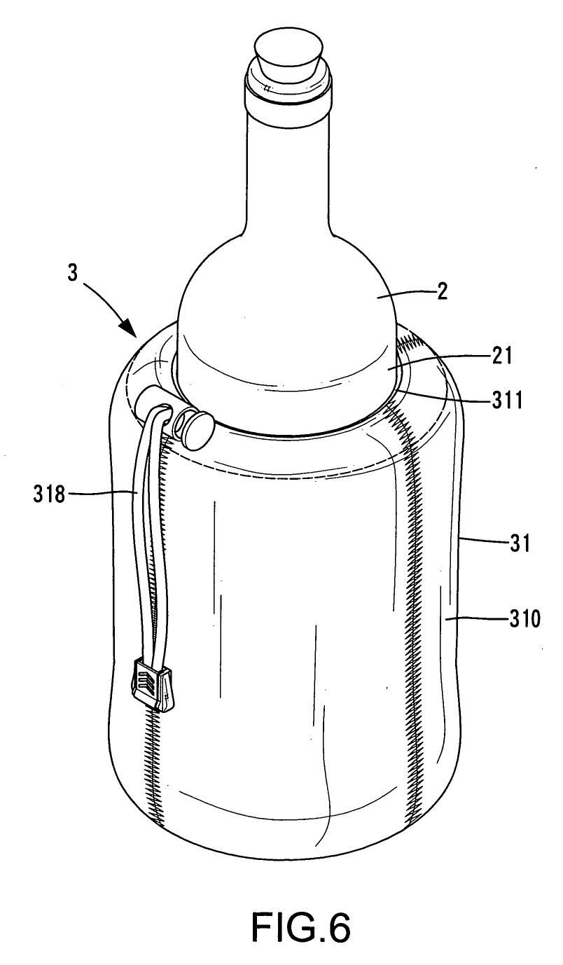

The temperature-maintaining member 31 includes a closed bottom end 312 on which the bottle 2 is located. Further the size of the open upper end 311 of the temperature-maintaining member 31 is adjustable. In the illustrated embodiment, the outer layer 310 of the temperature-maintaining member 31 includes a hollow looped upper end 316 through which a string 318 extends. The hollow looped upper end 316 includes a cutout 316a through which two ends of the string 318 extend out of the hollow lopped upper end 316. Further, an adjustable fastening member 319 is provided to adjust the size of the open upper end 311 of the temperature-maintaining member 31. In particular, the adjustable fastening member 319 includes a radial hole 319b and a push member 319a. The ends of the string 318 are passed through the radial hole 319b and coupled to an end piece 319c having a width greater than a diameter of the radial hole 319b to prevent disengagement of the string 318 from the fastening member 319. The push member 319a is biased by an elastic element (not shown) to a position clamping the sections of the strings 319b in the radial hole 319b, thereby retaining the position of the string 318. When the push member 319a is pushed, the adjustable fastening member 319 can be moved along the string 319 to a desired location, thereby adjusting size of the open upper end 311. For example, the adjustable fastening member 319 can be moved to a position shown in FIG. 6 to prevent disengagement of the bottle 2 from the temperature-maintaining device 3 or to a position shown in FIG. 5 allowing insertion/removal of the bottle 2 into/from a space 34 delimited by the temperature-maintaining device 3. It is noted that other arrangements allowing positioning of the bottle 2 in the space 34 delimited by the temperature-maintaining device 3 and insertion/removal of the bottle 2 into/from the space 34 delimited by the temperature-maintaining device 3 can be used.

Similar to the above embodiment, a plurality of holding sections 314 are provided on an inner face of the inner layer 310. In this embodiment, each holding section 314 is in the form of a piece of cloth sewn to the inner face of the inner layer 310 to form a pocket (not labeled). Further, a plurality of chilling members 32 are removably received in the holding sections 314 respectively. The chilling members 32 can be placed in a refrigerator before use. In use, the chilling members 32 are placed into the pockets for chilling purposes. After use, the chilling members 32 can be removed from the pockets and put into a refrigerator for next use. Again, conventional cooling members containing cooling medium can be used.

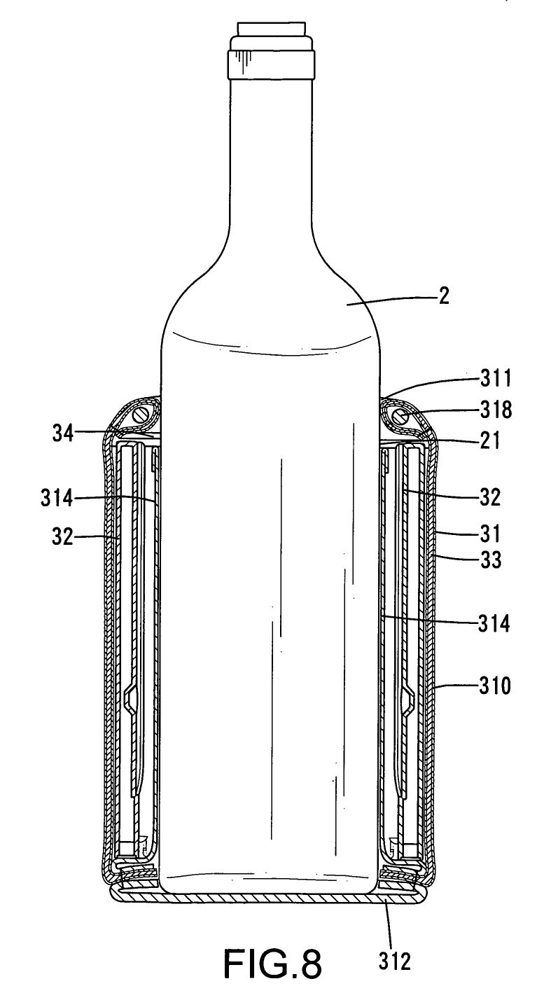

As illustrated in FIGS. 7 and 8, the chilling members 32 are in contact with the bottle 2 via the cloth forming the respective pockets. It is noted that the cloth can be cut to form at least one opening allowing direct contact between the chilling members 32 and the bottle 2. Further, other holding arrangements can be provided for allowing direct contact between the chilling members 32 and the bottle 2. Each chilling member 32 is preferably arcuate to conform to a section of the outer periphery of the bottle 2.

The liquor or beverage contained in the bottle 2 can be chilled to the desired temperature range by the chilling members 32. Further, the temperature-maintaining member 31 surrounding the bottle 2 forms an insulating layer to provide a longer temperature-maintaining effect.

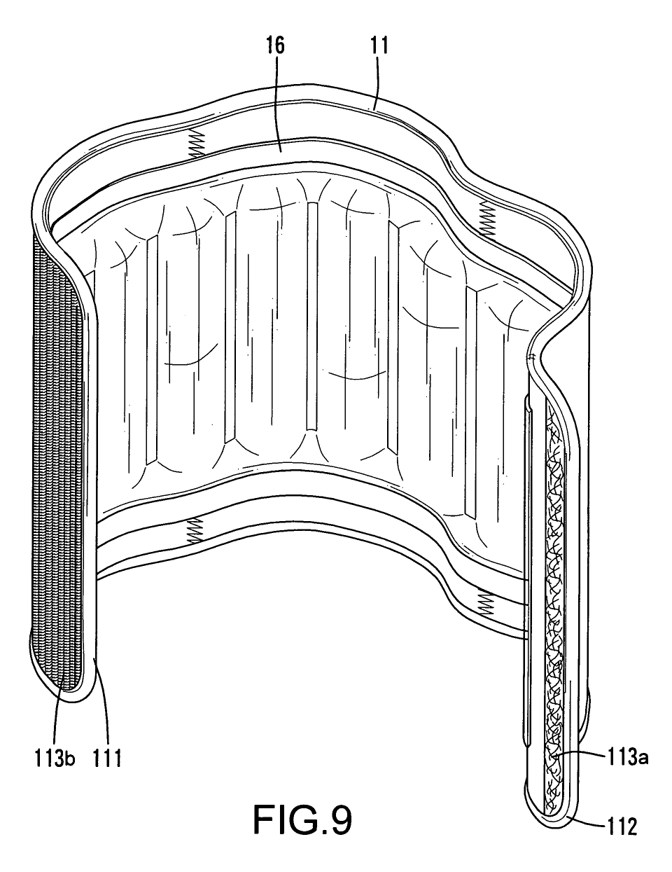

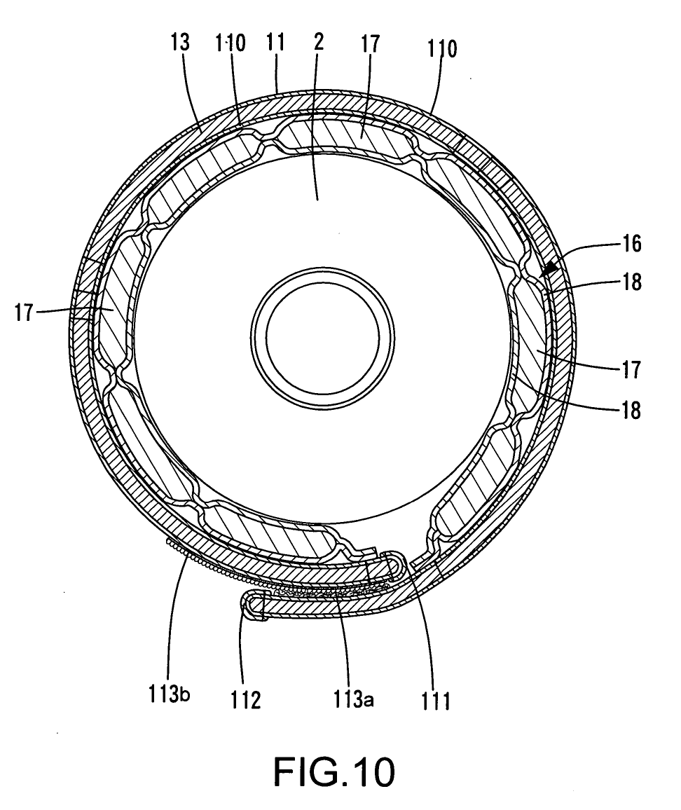

FIGS. 9 and 10 illustrates another embodiment modified from the first embodiment. In this embodiment, the chilling member is a gel pack 16 including a pair of plastic sheets 18 delimiting a receiving space for accommodating gel 17. The receiving space may include a plurality of sections that are in communication with each other. The plastic sheets 18 are bonded together along a perimeter thereof, preventing leakage of the gel. The gel pack 16 is sewn to the inner face of the inner layer 110 of the temperature-maintaining member 11 along the perimeter of the gel pack 17. The whole temperature-maintaining member 11 (including the gel pack 16) can be placed in a refrigerator before use. In use, the temperature-maintaining member 11 is wrapped around a bottle 2 containing liquor or beverage (FIG. 10) for chilling and temperature-maintaining purposes. After use, the temperature-maintaining member 11 is removed from the bottle 2 and put into a refrigerator for next use.

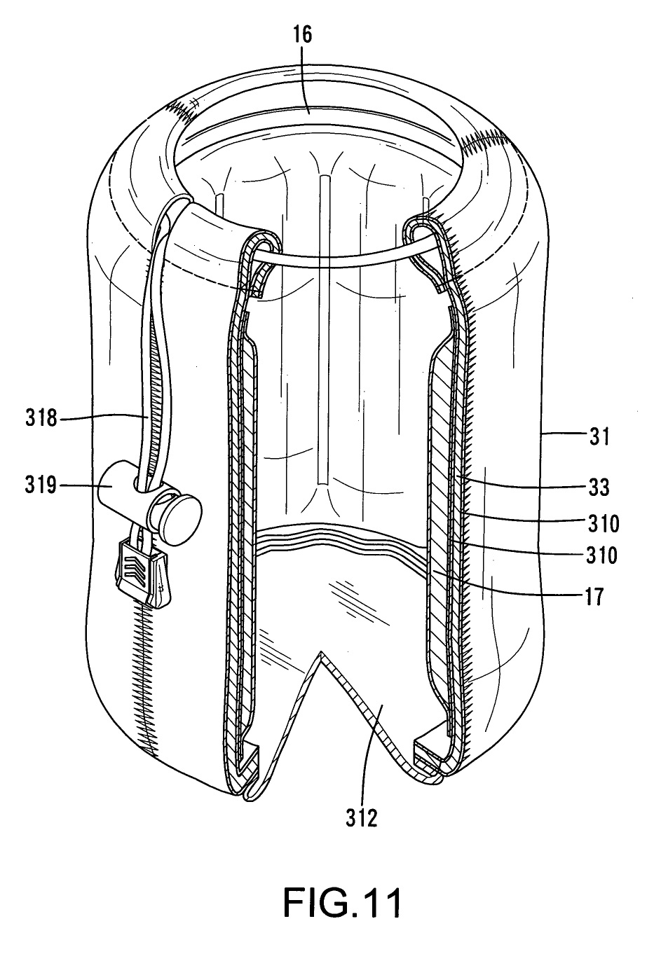

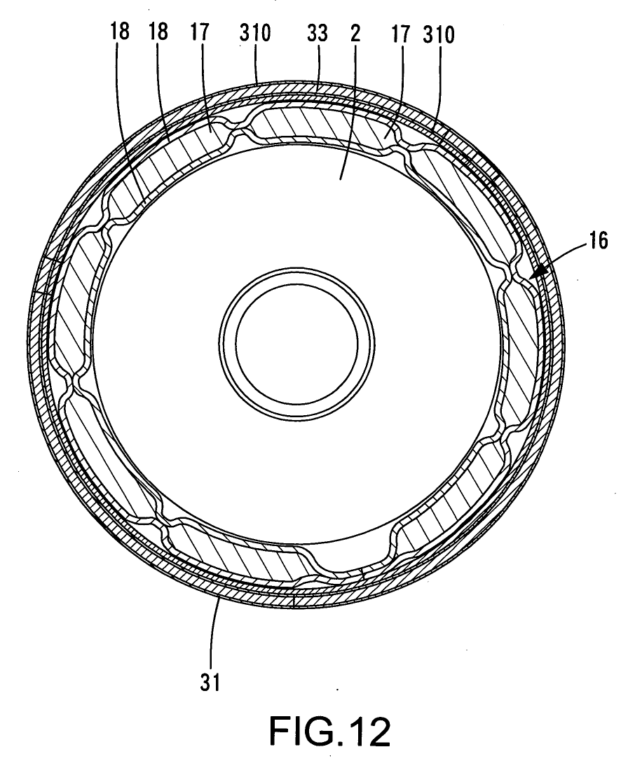

The gel pack 16 can be used with the second embodiment shown in FIGS. 5 through 8, best shown in FIGS. 11 and 12. Detailed description of the structure and use of the gel pack 16 is omitted to avoid redundancy.

Although specific embodiments have been illustrated and described, numerous modifications and variations are still possible without departing from the essence of the invention. The scope of the invention is limited by the accompanying claims.

What is claimed is:

1. A temperature-maintaining device comprising:
a temperature-maintaining member delimiting a space in which a container is removably received, the temperature-maintaining member including an inner layer, an outer layer, and a temperature-maintaining layer between the inner layer and the outer layer, the inner layer and the outer layer being made of one of nylon, polyester, and polyurethane, the temperature-maintaining layer being made of neoprene, the inner layer having an inner face; and
at least one chilling member mounted to the inner face of the inner layer of the temperature-maintaining member.

2. The temperature-maintaining device as claimed in claim 1, wherein the temperature-maintaining member includes two ends that are releasably engaged with each other to define the space for receiving the container.

3. The temperature-maintaining device as claimed in claim 2, wherein one of the ends of the temperature-maintaining member includes a plurality of hook fasteners, and wherein the other end of the temperature-maintaining member includes a plurality of loop fasteners for releasably engaging with the hook fasteners.

4. The temperature-maintaining device as claimed in claim 1, further comprising at least one holding section provided on the inner face of the inner layer of the temperature-maintaining member for removably receiving said at least one chilling member.

5. The temperature-maintaining device as claimed in claim 4, wherein said at least one holding section is a pocket.

6. The temperature-maintaining device as claimed in claim 5, wherein said at least one chilling member is a freezer containing cooling medium.

7. The temperature-maintaining device as claimed in claim 1, wherein said at least one chilling member is a gel pack fixed to the inner face of the inner layer of the temperature-maintaining member.

8. The temperature-maintaining device as claimed in claim 1, wherein the temperature-maintaining member is substantially a cylindrical hollow member having an open upper end and a closed bottom end.

9. The temperature-maintaining device as claimed in claim 8, further comprising means for adjusting a size of the open upper end.

10. The temperature-maintaining device as claimed in claim 2, further comprising at least one holding section provided on the inner face of the inner layer of the temperature-maintaining member for removably receiving said at least one chilling member.

11. The temperature-maintaining device as claimed in claim 10, wherein said at least one holding section is a pocket.

12. The temperature-maintaining device as claimed in claim 11, wherein said at least one chilling member is a freezer containing cooling medium.

13. The temperature-maintaining device as claimed in claim 2, wherein said at least one chilling member is a gel pack fixed to the inner face of the inner layer of the temperature-maintaining member.

14. The temperature-maintaining device as claimed in claim 8, wherein said at least one chilling member is a gel pack fixed to the inner face of the inner layer of the temperature-maintaining member.

15. The temperature-maintaining device as claimed in claim 1, wherein the temperature-maintaining member further includes a layer of titanium between the temperature-maintaining layer and one of the inner layer and the outer layer.

16. The temperature-maintaining device as claimed in claim 8, further comprising at least one holding section provided on the inner face of the inner layer of the temperature-maintaining member for removably receiving said at least one chilling member.

17. The temperature-maintaining device as claimed in claim 16, wherein said at least one holding section is a pocket.

18. The temperature-maintaining device as claimed in claim 17, wherein said at least one chilling member is a freezer containing cooling medium.

19. The temperature-maintaining device as claimed in claim 17, further comprising means for adjusting a size of the open upper end.

20. The temperature-maintaining device as claimed in claim 1, wherein the space includes an upper end, and wherein the temperature-maintaining device further comprises means for adjusting a size of the upper end.
